(19) United States
(12) Patent Application Publication
(10) Pub. No.: US 2008/0065913 A1
(43) Pub. Date: Mar. 13, 2008

(54) Portable information recording/reproduction device

(75) Inventors: Toshihiro Morohoshi, Kawasaki-shi (JP); Sumio Sakai, Osato-gun (JP); Toshiaki Matsubayashi, Ichikawa-shi (JP); Satoshi Kazuta, Tachikawa-shi (JP); Masanori Watanuki, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/898,424

(22) Filed: Sep. 12, 2007

(30) Foreign Application Priority Data
Sep. 13, 2006 (JP) 2006-248480

(51) Int. Cl. G06F 1/00

(52) U.S. Cl. 713/300

(57) ABSTRACT

According to one embodiment, in order to manage the remaining capacity of a secondary battery of an information recording/reproduction device, the remaining capacity of the secondary battery which supplies electric power to the whole device including a storage medium is monitored in accordance with current supply capacity and in accordance with voltage supply capacity. The remaining capacity is displayed on a display in accordance with the current supply capacity. The whole device is stopped when one of the current supply capacity and the voltage is below a system stop level indicating the electric power required on the startup of the storage medium.

### CROSS-REFERENCE TO RELATED APPLICATIONS

This application is based upon and claims the benefit of priority from Japanese Patent Application No. 2006-248480, filed Sep. 13, 2006, the entire contents of which are incorporated herein by reference.

### BACKGROUND

1. Field

One embodiment of the invention relates to a media player (music/image/video information recording/reproduction device) mainly used in a portable manner, and more particularly, it relates to the management of a voltage during an operation by a built-in secondary battery and to the protection of internal units and data on the occurrence of a sudden voltage drop.

2. Description of the Related Art

Recently, portable information recording/reproduction devices (media players) have been widely used, and these devices are mainly used in a portable manner and are capable of reproducing, as needed (anytime and anywhere), digitized music data or picture data contained in, for example, a solid-state memory such as a memory card or a hard disk.

The music data and picture data can be obtained in various manners, for example, through optical disks conforming to, for example, compact disk (CD) standards or DVD standards, or through public broadcasting provided using space waves (ground waves) or a broadcast satellite, or through downloading by access to a server (distribution site) via, for example, the Internet.

The portable information recording/reproduction device is, for its characteristics, mostly activated by a built-in secondary battery.

On the other hand, when a sudden voltage drop occurs in the secondary battery during access to the hard disk, that is, during the reading of data from the hard disk, data stored in the hard disk is damaged and the next data reproduction might be impossible.

For example, Japanese Patent Application Publication (KOKAI) No. 2000-112582 has reported a device provided with a unit for correcting the amount of a remaining current, and this unit monitors the amount of a remaining voltage to detect the remaining amount of a battery of a portable device, and corrects the remaining amount of a current when the amount of the remaining voltage is greater than a predetermined amount.

A method of displaying the amount of the remaining current in the Japanese Patent Application Publication (KOKAI) No. 2000-112582 is suitable to detect the remaining amount of the battery which can continue a steady operation of the portable device, but when a mechanism is included which requires high electric power (current) on the startup of, for example, a hard disk, this method, often times, can not allow a sudden voltage drop on the startup of the hard disk. That is, it can be easily known by analogy that the device might be stopped in an undesired condition where data can be damaged.

It is an object of this invention to provide a portable media player (music/image/video information recording/reproduction device) capable of preventing data held in a storage device (such as a hard disk) from being damaged due to a sudden voltage drop in a battery.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a media player (music/image/video information recording/reproduction device) according to an embodiment of the invention;

FIG. 2 is an exemplary diagram showing an example of the appearance characteristics of the media player shown in FIG. 1, according to an embodiment of the invention;

FIG. 3 is an exemplary diagram showing an example of the number of peripheral circuits/peripheral devices which may be simultaneously operated and changes in discharging characteristics (remaining capacity) of a battery (secondary battery) in the media player shown in FIGS. 1 and 2, according to an embodiment of the invention;

FIG. 4 is an exemplary diagram showing an example of the procedure of stopping the player in accordance with the discharging characteristics (remaining capacity) of the battery (secondary battery) of the media player shown in FIG. 3, according to an embodiment of the invention; and

FIG. 5 is an exemplary diagram showing an example of a change in the discharging characteristics (remaining capacity) of the battery (secondary battery) of the media player shown in FIGS. 1 and 2, according to an embodiment of the invention.

### DETAILED DESCRIPTION

Various embodiments according to the invention will be described hereinafter with reference to the accompanying drawings. In general, according to one embodiment of the invention, a portable information recording/reproduction device comprising: a storage medium operated by predetermined electric power; a secondary battery which supplies electric power to the whole device including the storage medium; a display which indicates information held in the storage medium and the remaining capacity of the secondary battery; a reproducer which reproduces the information held in the storage medium as music or sound; a first monitor which monitors the current supply capacity of the secondary battery; a second monitor which monitors the voltage supply capacity of the secondary battery; and a controller which stops the operation of the whole device including the storage medium on the basis of the monitoring results by the first and second monitors.

According to an embodiment of this invention will hereinafter be described with reference to the drawings.

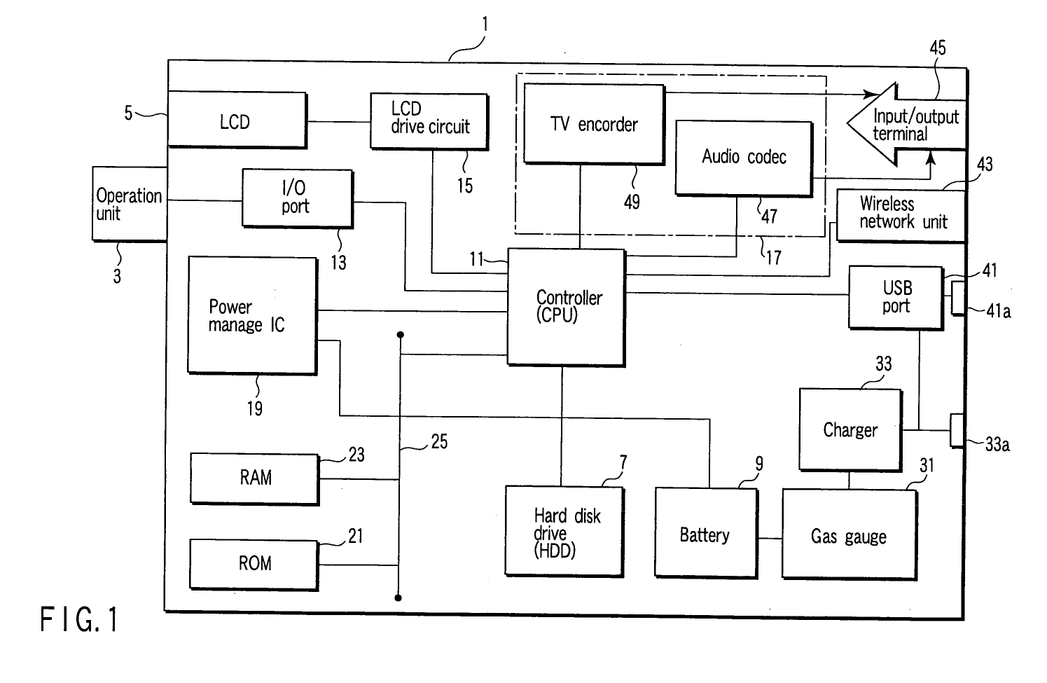

FIG. 1 is a schematic block diagram explaining the main configuration of a media player (music/image/video information recording/reproduction device) mainly used in a portable manner to which one embodiment of this invention is applied.

A media player (music/image/video information recording/reproduction device) 1 shown in FIG. 1 has: an operation unit 3 used to input control signals from a user and to input selection instruction signals; an LCD panel (liquid crystal display) 5 capable of displaying, for example, the file name of a currently played audio/music program, and moving images or still images which are reproductions of character information or picture data contained in an audio program; a hard disk drive (hereinafter represented as HDD) 7 provided with a storage capacity of, for example, several giga (G) bytes to several ten G bytes; a battery (secondary battery) 9 which serves as a power source when the media player is mainly used in a portable manner; a CPU 11 which is a main control unit; etc. In addition, the HDD 7 may be a unitized “mobile disk” detachable from the player 1.

The CPU 11 is connected to an input/output (I/O) port 13 for accepting the control signals input by the user operation on the operation unit 3, a display driver (LCD drive circuit) 15 for displaying images and character strings to be displayed on the LCD panel 5, an output unit 17 for converting picture data or audio/music data held in the HDD 7 into an analog output, a power management integrated circuit (IC) 19 for managing electric power provided by the battery 9, that is, a predetermined voltage and a permitted current, etc.

Furthermore, the CPU 11 is connected to a read only memory (ROM) 21 which is a system memory used to reproduce data stored in the HDD 7 and record data in the HDD 7 and to control, for example, the startup of the HDD 7 or the turning on/off of a main power source not shown, and a work memory, that is, a random access memory (RAM) 23 for temporarily holding, for example, control information or a command corresponding to the (input) control signal and for buffering a certain amount of data read from the HDD 7 via a control bus 25.

A predetermined DC voltage is supplied to the power management IC 19 to manage the electric power provided by the battery 9, that is, the predetermined voltage and the permitted current. In addition, the value of a current that can be supplied is arbitrarily set within the range of the maximum value of a current that can be supplied by the battery 9 in accordance with the number of internal units operated simultaneously (or in parallel) and the number of operation programs (applications) operated simultaneously (or in parallel) under the control of the CPU 11.

A charger 33 is connected to the battery 9 via a gas gauge 31 for monitoring the discharge state, that is, voltage supply capacity and current supply capacity of the battery 9. In addition, the charger 33 can be configured to directly accept a commercial power source (AC 100 V), but in this example, a DC voltage decreased/converted to a direct current (DC) of about 5 V is generally input from a power supply input unit 33a by an unshown external power supply unit in order to reduce the size of the player 1.

In addition, the CPU 11 is connected to a universal serial bus (USB) port 41 which serves as the supply source of picture data (including character data) and music data (including audio data) and which is used to pass data from/to, for example, a personal computer, a wireless network (wireless local area network) unit (communication unit) 43, an output terminal 45 used for ordinary analog output, etc.

The USB port 41 is used to transfer the music data (audio data) to an external device such as an audio-only player (USB flash memory player) containing a semiconductor memory or a USB speaker from the player 1 via a USB connector 41a and to input music/audio signals from a microphone (external input). In addition, for example, a card slot (multiadapter) can be connected to the USB connector 41a to enable the passage of data from/to a semiconductor memory such as an “SD card”, a “mini-SD card (trademark)”, a “compact flash (trademark)” or a “memory stick (trademark)” which is a storage medium independent from the HDD 7.

It goes without saying that the wireless network unit 43 may be only provided with Bluetooth compliant with the protocol of a (high-speed) communication standard using radio waves at 2.4 GHz and 5.2 GHz bands, may be only provided with a general purpose wireless LAN device compliant with IEEE802.11a/b/g, or may be provided with a combination of the two. In other words, when the wireless LAN device or Bluetooth is incorporated, data can be passed to/from, for example, server computers or personal computers located in households or in a specific range which satisfies predetermined conditions. Therefore, for example, the player 1 can be brought to, for example, a download center running in town to directly download contents (which often have to be paid for).

Music or sound demodulated to an analog signal by an audio codec 47 provided in the output unit 17 is supplied to the output terminal 45 used for the analog output. Thus, for example, headphones or a speaker with an amplification function are attached to the output terminal 45 to play the music or sound. It should be understood that the output from the output terminal 45 can be input to an amplifier (not shown) and a speaker (not shown) can then be connected to the amplifier to obtain a higher sound volume. In addition, an analog signal directly input from an unshown microphone or a line input (external input) terminal can be A/D converted and input as a digital signal to the audio codec 47.

The output terminal 45 is also provided with a television (TV) encoder (video encoder) 49 which is disposed in the output unit 17. Thus, the picture data held in, for example, the HDD 7 can be transferred to and played on an unshown monitor unit or television set.

In the player 1 described above, data such as precompressed music data, image data or video data (contents) are recorded in the HDD 7 in accordance with a predetermined rule. In addition, the following methods are used for the compression of data, such as MP3, WMA, etc., for the compression of the music data, JPG, GIF, BMP, etc., for the compression of the image data, and WMV, MPEG, etc., for the compression of the video data. Although not described in detail, the data stored in the HDD 7 can also be saved in an encrypted format to only permit direct playback using the player 1 and the output to, for example, an external speaker in the form of an analog signal, in order to prevent copying (except for copying for which the number of times is determined) other than copying for “private use” defined by the Copyright Act.

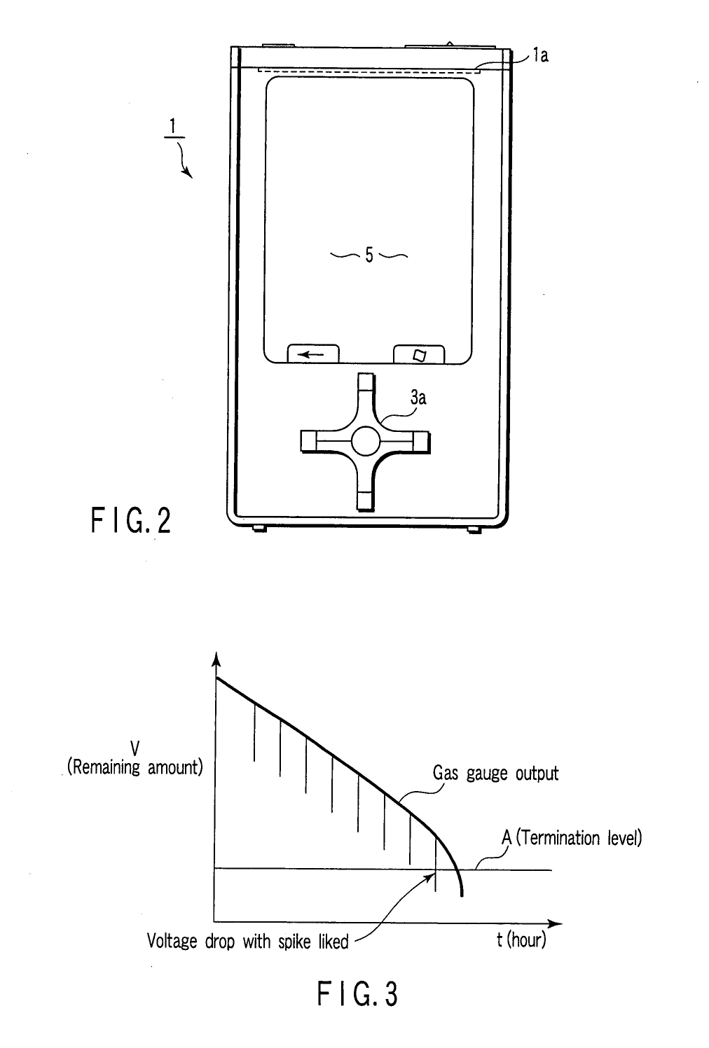

In addition, as the appearance of the player 1 is shown in FIG. 2, the operation unit 3 includes a multifunction button 3a used to input control commands for instructing to start or stop the playback of music/image/video, for switching information displayed on the LCD 5 and for scrolling song lyrics or character information for a program displayed on the LCD 5. For example, when a central button is pushed, the multifunction button 3a can input an on-signal for instructing to start or stop the playback mentioned above. When any one of four-direction (generally called “vertical and horizontal”) buttons is pushed, the multifunction button 3a enables the input of a control command (instruction) to scroll, for example, the image or character strings displayed on the LCD 5 in a direction of the button to which force is applied. Moreover, the wireless network unit 43 and an antenna 1a for wireless communications with the outside are provided at predetermined positions of the player 1. In addition, the antenna 1a is preferably provided in a part of a member forming the player 1 for which a nonmetal material is used, for example, on the periphery of the LCD 5 or in the vicinity of an unshown power supply switch on the side surface of the player 1.

On the other hand, a relatively high electric power (a high value of a current released from the battery 9) is required on startup because the HDD 7 (hard disk drive) includes a motor. Thus, in a device (portable media player) using the HDD 7, reading and stopping are repeated to decrease power consumption so that a certain amount of data is read from the recording medium (HDD 7) and buffered in the RAM 23 and then the driving of the HDD 7 is stopped.

However, it is known that a terminal voltage of the battery 9 extremely falls (a sudden spike-shaped voltage drop occurs) as shown in FIG. 3 when the rotation of the drive (HDD 7) is started.

This includes a factor for the impossibility of the next data reproduction (necessity for a reset operation) due to damage to the data stored in the HDD 7 from a sudden voltage drop in the battery 9 during access to the HDD 7, that is, during the reading of the data from the HDD 7.

Therefore, in order to manage the remaining amount (voltage supply capacity and current supply capacity) of the battery 9, it is necessary to monitor the voltage so that the voltage when extremely fallen as described above (voltage suddenly dropped in a spike shape) may not be less than a system termination condition (indicated by “A” in FIG. 3) which enables the player (system) 1 to be safely stopped, in the case where a device such as the HDD 7 requiring a relatively high electric power on startup is incorporated.

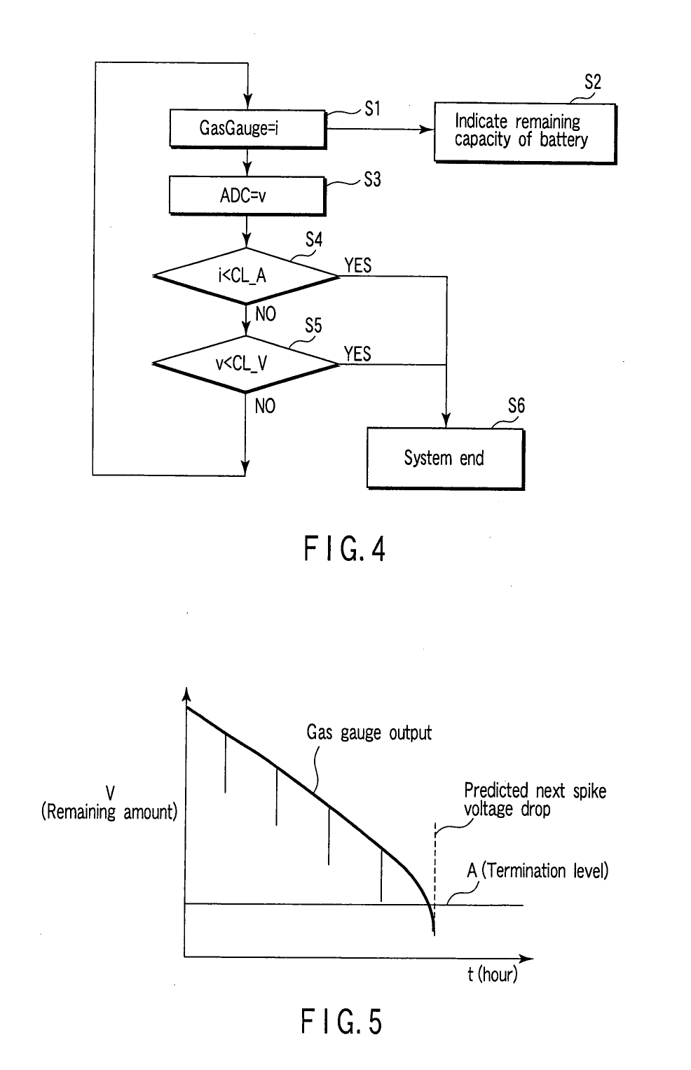

FIG. 4 shows one example of a voltage management method which enables the player (system) 1 to be safely stopped without affecting the continuous operation of the system (player) 1 even when the spike-shaped voltage drop shown in FIG. 3 occurs.

First, the output of the gas gauge 31 is monitored, and set to “i”. In addition, the output of the gas gauge 31 mainly indicates “current supply capacity A” (S1).

The remaining capacity (current supply capacity) of the battery 9 found by the gas gauge 31 in step S1 is indicated by, for example, a bar graph or a numerical value at a predetermined position in the LCD 5 (S2).

Next, a voltage monitor output ADC of the power management IC 19 is monitored, and set to “v”. In addition, the output of the power management IC 19 mainly indicates “voltage supply capacity V” (S3).

Subsequently, the “current supply capacity A” of the battery 9 obtained by the gas gauge 31 is compared with a termination condition CL to stop the player (system) 1 (I<CL_A). In addition, the current supply capacity A is useful to monitor the remaining capacity of the battery 9 when a discharge current decreases even if the voltage supply capacity V is equal to or higher than a certain level, for example, in a condition where the battery 9 is left at a low temperature (S4).

Then, the “voltage supply capacity V” of the battery 9 obtained by the power management IC 19 is compared with the termination condition CL to stop the player (system) 1 (v<CL_V). In addition, as described above, it is preferable to use the “current supply capacity A” obtainable by the gas gauge 31 in combination with the “voltage supply capacity V”, that is, the battery terminal voltage obtainable by the power management IC 19 in order to accurately monitor the remaining capacity of the battery 9 (S5).

When one of step S4 and step S5 detects that one of the “current supply capacity A” and “voltage supply capacity V” of the battery 9 is below the termination condition CL which enables the system (player) 1 to be safely stopped without affecting the continuous operation of the system 1, a message such as “Remaining amount of battery is small. Turn off power” or “Remaining amount of battery is small. Connect AC power” is indicated on the LCD 5 under the control of the CPU 11, and then the operation of the system 1 is stopped (S6).

Thus, the output of the gas gauge 31 is used to display the remaining capacity of the battery to be indicated to the user, and the battery terminal voltage is used to prevent an abnormal end of the system due to a sudden voltage drop occurring during the rotation of the HDD 7, such that it is possible to prevent the abnormal end of the system (player) 1, for example, the impossibility of the next data reproduction due to damage to the data stored in the HDD 7 from a sudden voltage drop in the battery 9 during access to the HDD 7, that is, during the reading of the data from the HDD 7.

The management of the remaining capacity of the battery 9 using the termination condition CL shown in FIG. 4 makes it possible to report the remaining capacity of the battery 9 to the user with high accuracy, for example, even when the voltage drops during the playback of a video but the remaining capacity of the battery 9 temporarily recovers by canceling the video playback and switching to a music playback mode. For example, the indication of the remaining capacity of the battery displayed at a predetermined position in the LCD 5 is prevented from wobbling (displayed as if the remaining capacity were temporarily increased).

In addition, due to the relation between the period of reading a group of data from the storage medium and the size of a memory secured as a buffer, the voltage may be below a system termination voltage even during a period in which the spike-liked voltage drop is repeated as shown in FIG. 5 if the period of reading a group of data is relatively long in the case of control where the “voltage supply capacity V” shown in FIG. 4 is used to stop the system (player) 1.

Thus, in order to safely stop the system (player) 1, it is preferable to not only monitor the output of the power management IC 19 but also use, as the system termination condition, the value of the “current supply capacity A” of the battery 9 obtained by the gas gauge 31.

As described above, according to the arbitrary embodiment of this invention, the system is safely stopped when the remaining capacity of the battery is below a predetermined level in the portable media player.

Thus, the system is prevented from occurrence of abnormal stoppage of the system (player), for example, the impossibility of the next data reproduction (necessity for a reset operation) due to damage to the data stored in the storage medium from a sudden voltage drop in the battery. This enhances the convenience for the user.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, the storage medium is not limited to the hard disk drive, and it goes without saying that a storage system which uses a motor to rotate a recording medium disk may be incorporated, such as an optical disk drive which uses an optical disk.

What is claimed is:

1. A portable information recording/reproduction device comprising:
a storage medium operated by predetermined electric power;
a secondary battery which supplies electric power to the whole device including the storage medium;
a display which indicates information held in the storage medium and the remaining capacity of the secondary battery;
a reproducer which reproduces the information held in the storage medium as music or sound;
a first monitor which monitors the current supply capacity of the secondary battery;
a second monitor which monitors the voltage supply capacity of the secondary battery; and
a controller which stops the operation of the whole device including the storage medium on the basis of the monitoring results by the first and second monitors.

2. The portable information recording/reproduction device according to claim 1, wherein
the controller displays the monitoring result of the first monitor on the display.

3. The portable information recording/reproduction device according to claim 1, wherein
the controller displays the stopping of the device on the display and stops the whole device including the storage medium with predetermined timing when at least one of the monitoring results by the first monitor and the second monitor is below a predetermined level.

4. A portable information recording/reproduction device comprising:
a storage medium which requires predetermined electric power involving a voltage drop on startup;
a secondary battery which supplies electric power to the whole device including the storage medium;
a display which indicates information held in the storage medium;
a reproducer which reproduces the information held in the storage medium as music or sound;
a first monitor which monitors the current supply capacity of the secondary battery;
a second monitor which monitors the voltage supply capacity of the secondary battery; and
a controller which stops the operation of the whole device including the storage medium with predetermined timing on the basis of the monitoring results by the first and second monitors while predicting the timing of the next start of the storage medium.

5. The portable information recording/reproduction device according to claim 4, wherein
the controller displays the monitoring result of the first monitor on the display.

6. The portable information recording/reproduction device according to claim 4, wherein
the controller displays the stopping of the device on the display and stops the whole device including the storage medium with predetermined timing when at least one of the monitoring results by the first monitor and the second monitor is below a predetermined level.

7. A method of managing the remaining capacity of a secondary battery of a portable information recording/reproduction device, the method comprising:
monitoring the remaining capacity of the secondary battery which supplies electric power to the whole device including a storage medium in accordance with current supply ability;
monitoring the remaining capacity of the secondary battery which supplies electric power to the whole device including the storage medium in accordance with voltage supply ability;
displaying the remaining capacity on a display on the basis of the current supply ability; and
stopping the whole device when one of the current supply ability and the voltage supply ability is below a system stop voltage indicating electric power required on the startup of the storage medium.
